(19) United States
(12) Patent Application Publication
(10) Pub. No.: US 2013/0266906 A1
(43) Pub. Date: Oct. 10, 2013

(54) ORTHODONTIC SYSTEMS

(71) Applicant: B. Chia Soo, Beverly Hills, CA (US)

(72) Inventor: B. Chia Soo, Beverly Hills, CA (US)

(73) Assignee: THE REGENTS OF THE UNIVERSITY OF CALIFORNIA, Oakland, CA (US)

(21) Appl. No.: 13/702,578

(22) PCT Filed: Jun. 2, 2011
(86) PCT No.: PCT/US2011/038966

§ 371 Date: May 13, 2013

Related U.S. Application Data
(60) Provisional application No. 61/352,288, filed on Jun. 7, 2010.

(51) Int. Cl. A61C 7/08

(52) U.S. Cl. CPC A61C 7/08
USPC 433/6; 433/24; 29/896.11

(57) ABSTRACT

Provided herein is a force system for repositioning teeth and the methods of making and using the system.

### FIELD OF THE INVENTION

The present invention is related generally to the field of orthodontics.

### BACKGROUND OF THE INVENTION

Conventional method of repositioning teeth is to make users wear what are commonly referred to as “braces.” Braces include a variety of appliances such as brackets, archwires, ligatures, and O-rings. The procedures of conventional orthodontics are briefly described here: Before fastening braces to a user's teeth, at least one appointment is typically scheduled with the orthodontist, dentist, and/or X-ray laboratory so that X-rays and photographs of the user's teeth and jaw structure can be taken. Also during this preliminary meeting, or possibly at a later meeting, an alginate mold of the user's teeth is typically made. This mold provides a model of the user's teeth that the orthodontist uses in conjunction with the X-rays and photographs to formulate a treatment strategy. The orthodontist then typically schedules one or more appointments during which braces will be attached to the user's teeth.

At the meeting during which braces are first attached, the teeth surfaces are initially treated with a weak acid the acid optimizes the adhesion properties of the teeth surfaces for brackets and bands that are to be bonded to them. The brackets and bands serve as anchors for other appliances to be added later. After the acid step, the brackets and bands are cemented to the user's teeth using a suitable bonding material. No force-inducing appliances are added until the cement is set. For this reason, it is common for the orthodontist to schedule a later appointment to ensure that the brackets and bands are well bonded to the teeth.

The primary force-inducing appliance in a conventional set of braces is the archwire. The archwire is resilient and is attached to the brackets by way of slots in the brackets. The archwire links the brackets together and exerts forces on them to move the teeth over time. Twisted wires or elastomeric O-rings are commonly used to reinforce attachment of the archwire to the brackets. Attachment of the archwire to the brackets is known in the art of orthodontia as “ligation” and wires used in this procedure are called “ligatures.” The elastomeric O-rings are called “plastics.”

After the archwire is in place, periodic meetings with the orthodontist are required, during which the user's braces will be adjusted by installing a different archwire having different force inducing properties or by replacing or tightening existing ligatures. Typically, these meetings are scheduled every three to six weeks.

Problems exist in the conventional orthodontics. Such problems include, e.g., patient discomfort, lack of effective hygiene means in the oral cavity leading to oral or periodontal infections, and being aesthetically unappealing, to name a few.

Various methods have been proposed to provide alternative orthodontic treatment with limited success. For example, Kuroda et al. (1996) Am. J. Orthodontics 110:365-369 describes a method for laser scanning a plaster dental cast to produce a digital image of the cast. See also U.S. Pat. No. 5,605,459. U.S. Pat. Nos. 5,533,895; 5,474,448; 5,454,717; 5,447,432; 5,431,562; 5,395,238; 5,368,478; and 5,139,419, assigned to Ormco Corporation, describe methods for manipulating digital images of teeth for designing orthodontic appliances.

U.S. Pat. No. 5,011,405 describes a method for digitally imaging a tooth and determining optimum bracket positioning for orthodontic treatment. Laser scanning of a molded tooth to produce a three-dimensional model is described in U.S. Pat. No. 5,338,198. U.S. Pat. No. 5,452,219 describes a method for laser scanning a tooth model and milling a tooth mold. Digital computer manipulation of tooth contours is described in U.S. Pat. Nos. 5,607,305 and 5,587,912. Computerized digital imaging of the jaw is described in U.S. Pat. Nos. 5,342,202 and 5,340,309. Other patents of interest include U.S. Pat. Nos. 5,549,476; 5,382,164; 5,273,429; 4,936,862; 3,860,803; 3,660,900; 5,645,421; 5,055,039; 4,798,534; 4,856,991; 5,035,613; 5,059,118; 5,186,623; and 4,755,139.

U.S. Pat. Nos. 6,398,548 and 6,554,611 describes using a computer program predict the teeth movement from initial tooth positions to the final tooth positions and design and fabricate a series of appliances having different geometries to achieve the repositioning of the teeth from their initial positions to their final positions in one set of appliances in that the user receives a whole set of appliances from the beginning to the finish. The appliances are numbered or marked in the sequence for use. The problem is that if certain tooth movement is behind the expected tooth position, the discrepancy between actual tooth position and expected (predicted) tooth position will most likely increase further and further during the course of repositioning. In addition, teeth with increased discrepancies between actual and expected positions will experience a disproportionate load of force relative to the other teeth and lead to increased patient pain and discomfort. Additionally, invisible plastic aligners provide weak aligning forces so as to limit their application to light cases where weak aligning forces are capable of achieving tooth-realignment or rearrangement. This causes invisible plastic aligners to be capable of providing largely cosmetic treatment and incapable of providing hardcore orthodontic treatment. However, these aligners can be effective to serve as temporary retainers.

Another type of common orthodontic devices is removable aligner (see FIGS. 1-4). However, such aligners also cause discomfort and speaking hindrance. Patients are reluctant to wear such these in the day time. This will cause the tooth under orthodontic treatment to bounce back/relapse to its original position so as to decrease the effectiveness of orthodontic treatment using these removable devices.

The embodiments described below address the above identified needs and issues.

### SUMMARY OF THE INVENTION

In one aspect of the present invention, it is provided a system for repositioning teeth from an initial arrangement to a final arrangement, the system comprising:

a) at least one removable aligner having a geometry selected to reposition the teeth from the initial arrangement to an intermediate arrangement or the final arrangement,

b) at least one appliance having a corresponding geometry of the intermediate arrangement or the final arrangement;

wherein the removable aligner provides an aligning force to progressively reposition the teeth from the initial arrangement to the intermediate arrangement or the final arrangement;

wherein the appliance holds the teeth in the intermediate arrangement or the final arrangement.

In some embodiments, the intermediate arrangement comprises two or more sequential sub-intermediate arrangements,

wherein the system comprises two or more removable aligners and two or more appliances,

wherein the removable aligners progressively reposition the teeth:
from the initial tooth arrangement to one sub-intermediate arrangement;
from one sub-intermediate arrangement to a successive sub-intermediate arrangement to the final tooth arrangement; or
from one sub-intermediate arrangement to the final arrangement; and

wherein the appliances hold the teeth in the one sub-intermediate arrangement, the successive sub-intermediate, or the final arrangement.

In some embodiments, the system comprising 3 or more removable aligners and 3 or more appliances; 4 or more removable aligners and 4 or more appliances; 5 or more removable aligners and 5 or more appliances.

In some embodiments, optionally in combination with any or all the above embodiments, the appliance comprises polymeric shells having cavities shaped to receive and hold teeth in the intermediate arrangement or the final arrangement.

In some embodiments, optionally in combination with any or all the above embodiments, the appliances comprise appliances polymeric shells having cavities shaped to receive and hold the teeth in the one sub-intermediate arrangement, the successive sub-intermediate, or the final arrangement.

In some embodiments, optionally in combination with any or all the above embodiments, the linear distance from the initial arrangement to the intermediate arrangement is at least 0.2 mm, or at least 0.5 mm.

In some embodiments, optionally in combination with any or all the above embodiments, the linear distance:
from the initial tooth arrangement to one sub-intermediate arrangement is at least 0.2 mm or at least 0.5 mm;
from one sub-intermediate arrangement to a successive sub-intermediate arrangement to the final tooth arrangement is at least 0.2 mm or at least 0.5 mm; or
from one sub-intermediate arrangement to the final arrangement is at least at least 0.2 mm or at least 0.5 mm.

In another aspect of the present invention, it is provided a method of fabricating a system for repositioning teeth from an initial arrangement to a final arrangement. The system is as described above.

In another aspect of the present invention, it is provided a method of aligning teeth, comprising applying to a patient orthodontic system. The system is as described above.

In some embodiments, optionally in combination with any or all the above embodiments, the teeth have a disorder selected from the group consisting of malalignment, crowding, spacing, overjet, overbite problem, and a combination thereof.

### BRIEF DESCRIPTION OF THE DRAWINGS

FIG. 1 shows several exemplary removable aligners (also described as aligners) commonly known in the art, namely, mini-expansion screw aligners, Bloore aligners, spring loaded microscrew aligners, 2-way saggital aligners, and 3-way saggital aligners that can be used in the present invention.

FIG. 2 shows examples of Inman spring aligners that can be used in the present invention.

FIG. 3 shows some examples of invisible removable aligners that can be used in the present invention.

FIG. 4 shows some further examples of invisible removable aligners that can be used in the present invention.

### DESCRIPTION OF DETAILED INVENTION

In one aspect of the present invention, it is provided a system for repositioning teeth from an initial arrangement to a final arrangement, the system comprising:

a) at least one removable aligner having a geometry selected to reposition the teeth from the initial arrangement to an intermediate arrangement or the final arrangement,

b) at least one appliance having a corresponding geometry of the intermediate arrangement or the final arrangement;

wherein the removable aligner provides an aligning force to progressively reposition the teeth from the initial arrangement to the intermediate arrangement or the final arrangement;

wherein the appliance holds the teeth in the intermediate arrangement or the final arrangement.

In some embodiments, the intermediate arrangement comprises two or more sequential sub-intermediate arrangements,

wherein the system comprises two or more removable aligners and two or more appliances,

wherein the removable aligners progressively reposition the teeth:
from the initial tooth arrangement to one sub-intermediate arrangement;
from one sub-intermediate arrangement to a successive sub-intermediate arrangement to the final tooth arrangement; or
from one sub-intermediate arrangement to the final arrangement; and

wherein the appliances hold the teeth in the one sub-intermediate arrangement, the successive sub-intermediate, or the final arrangement.

In some embodiments, the system comprising 3 or more removable aligners and 3 or more appliances; 4 or more removable aligners and 4 or more appliances; 5 or more removable aligners and 5 or more appliances.

In some embodiments, optionally in combination with any or all the above embodiments, the appliance comprises polymeric shells having cavities shaped to receive and hold teeth in the intermediate arrangement or the final arrangement.

In some embodiments, optionally in combination with any or all the above embodiments, the appliances comprise appliances polymeric shells having cavities shaped to receive and hold the teeth in the one sub-intermediate arrangement, the successive sub-intermediate, or the final arrangement.

In some embodiments, optionally in combination with any or all the above embodiments, the linear distance from the initial arrangement to the intermediate arrangement is at least 0.2 mm, or at least 0.5 mm.

In some embodiments, optionally in combination with any or all the above embodiments, the linear distance:
from the initial tooth arrangement to one sub-intermediate arrangement is at least 0.2 mm or at least 0.5 mm;
from one sub-intermediate arrangement to a successive sub-intermediate arrangement to the final tooth arrangement is at least 0.2 mm or at least 0.5 mm; or
from one sub-intermediate arrangement to the final arrangement is at least at least 0.2 mm or at least 0.5 mm.

In another aspect of the present invention, it is provided a method of fabricating a system for repositioning teeth from an initial arrangement to a final arrangement. The system is as described above.

In another aspect of the present invention, it is provided a method of aligning teeth, comprising applying to a patient orthodontic system. The system is as described above.

In some embodiments, optionally in combination with any or all the above embodiments, the teeth have a disorder selected from the group consisting of malalignment, crowding, spacing, overjet, overbite problem, and a combination thereof.

As used herein, the terms “tooth” and “teeth” are interchangeable.

As used herein, the terms “align”, “realign”, “rearrange” and “reposition” are interchangeable.

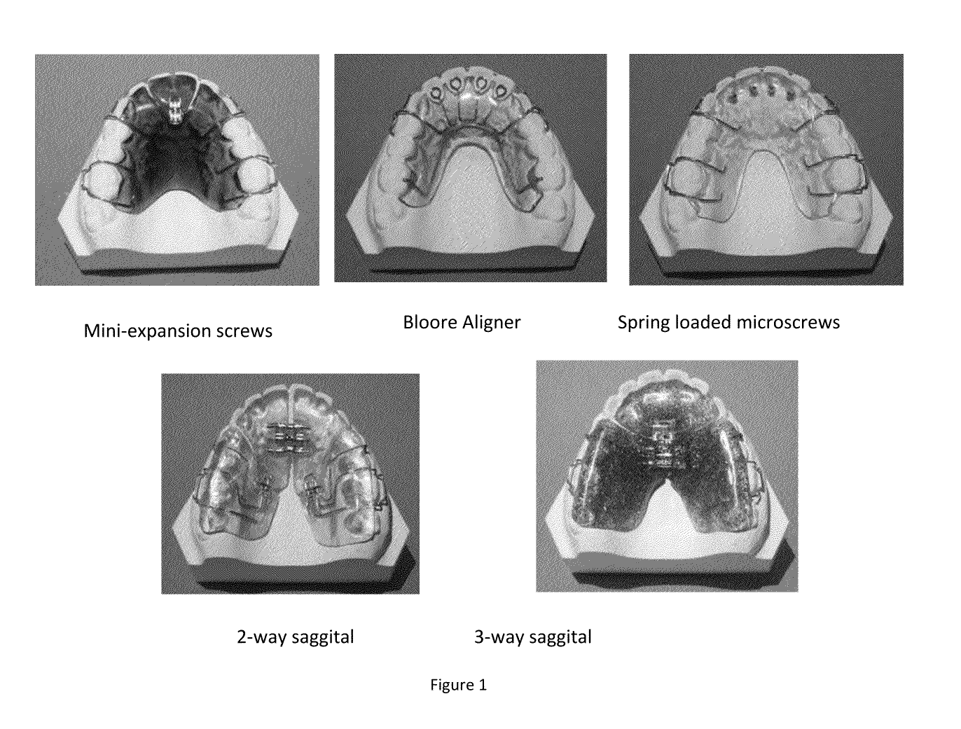

As used herein, the term “removable aligner” is used to denote an aligner that is different from an appliance. Examples of such removable aligners are shown in FIGS. 1-4. In some embodiments, a removable aligner can also refer to a removable retainer similar to Hawley retainers and ASTICS™ retainers. In contrast, an appliance, as used herein, generally refers to elastic polymeric appliance as described below, which is sometimes clear and invisible.

As used herein, the term “corresponding” shall mean an appliance having the same geometry for a particle tooth arrangement as that of a removable aligner.

### Removable Aligners

The removable aligners described herein can be of any design. FIG. 1 provides several exemplary removable aligners (also described as aligners) commonly known in the art, namely, mini-expansion screw aligners, Bloore aligners, spring loaded microscrew aligners, 2-way saggital aligners, and 3-way saggital aligners. Each of these aligners provides aligning forces and can be tailored to apply to a patient with a particular orthodontic condition.

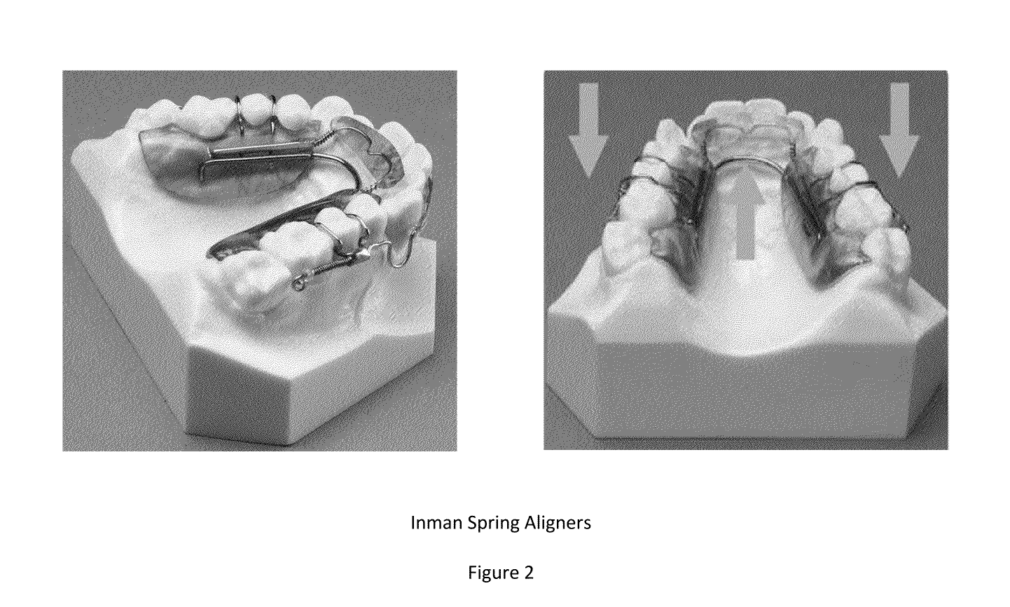

FIG. 2 shows other examples of removable aligners, which are referred to as Inman spring aligners. A removable orthodontic appliance repositions misaligned anterior teeth mainly with different designs. For example, one design of an embodiment of such removable aligners is as below:

1. a labial wire with acrylic padding and a palatal//lingual wire with acrylic padding.
2. a plurality of springs and a labial wire each secured to an acrylic palatal fitting. Each spring has a head portion in the shape of an eyelet which is positioned on the lingual side of an anterior tooth and a foot portion secured to the fitting. The springs provide lingual-to-labial force to the teeth, and the labial wire provides labial-to-lingual force to the teeth. A spring may engage the lingual surface of a tooth to provide active force to urge the tooth labially into a proper position, or may be spaced away from a tooth at a desired position to engage the tooth as it move lingually. The springs may be positioned on a mesial or a distal surface of a tooth to induce rotation. Further, the springs may provide passive resistance to maintain a properly positioned tooth in place. Each spring is made of a single strand of wire which has one end terminating at the head portion and the other end terminating at the foot portion. The orthodontic appliance also has a pair of stress-breaking clasps which dislodge the appliance if the labial wire or the springs are too heavily activated. (http://www.freepatentsonline.com/5580243.html)
More design: http://aztecortholab.com/springtooth.htm
http://www.greatlakesortho.com/lab-services/featured-appliances/inman-aligner/

In one embodiment, the removable aligner is an Inman Aligner™. The Inman Aligner™ appliances are designed for quick correction of anterior rotations, crowding, and adult relapse without the need for multiple appliances.

The Inman Aligner appliances use NiTi coil springs to apply steady, gentle forces to teeth—without the need for costly multiple appliances to complete correction. Both the lingual and labial components work together as opposing piston-like forces to move teeth. The Inman appliances achieve controlled, continuous movement of the anterior teeth (2×2). These pre-programmed appliances make adjustments virtually unnecessary. Precision alignment is accomplished with just one appliance. For more information, download the fliers and brochures below or go to www.inmanaligner.com.

Note, the aligners shown in FIGS. 1 and 2 all include metallic wiring that fits the outer contour or surface of teeth and a plastic base for setting in the inner contour of teeth. The plastic base may further include one or more springs to provide aligning forces tailored to target at one or more teeth.

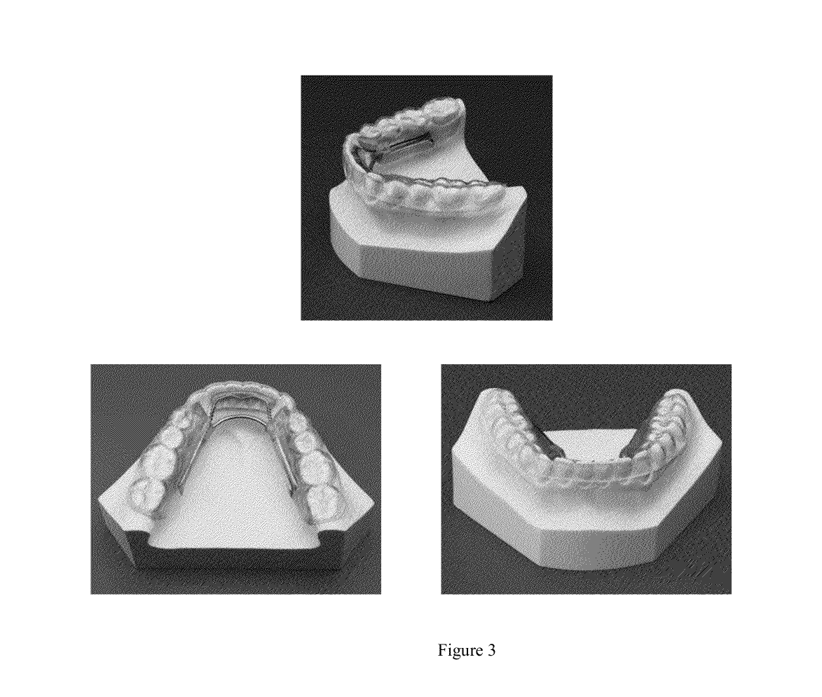

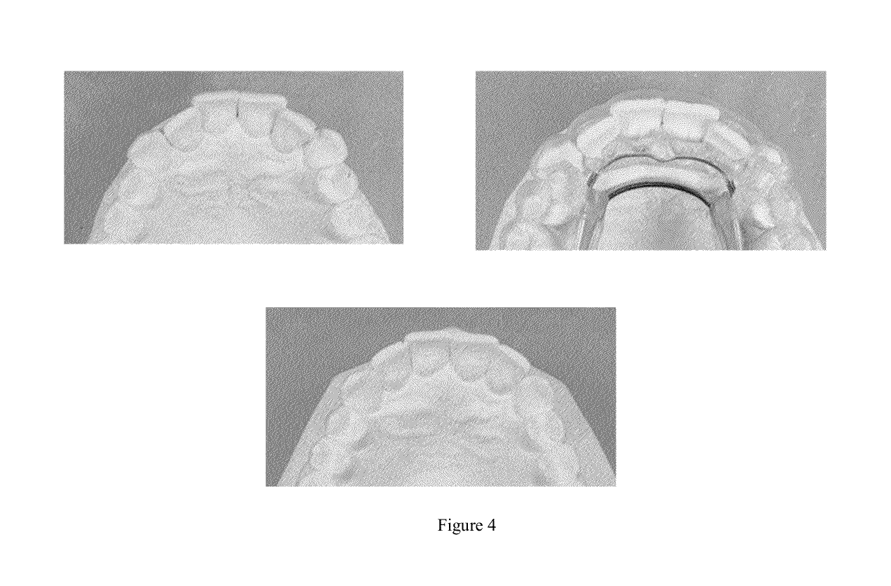

FIG. 3-4 show examples of invisible removable aligners. In these examples, the part that fits in the outer contour or surface of teeth is made of a clear plastic material so as to become invisible.

The removable aligners can be designed and formed by established methods of computer-aided fabrication. Generally, such methods generally include:

obtaining a digital data set representing the initial tooth arrangement of one or more teeth,

generating a digital image representing the initial tooth arrangement,

moving one or more teeth in the digital image representing the initial tooth arrangement to generate a digital image representing a final tooth arrangement,

moving one or more teeth in the digital image representing the initial tooth arrangement or the digital image representing a final tooth arrangement to generate one or more digital images representing one or more intermediate tooth arrangements, the one or more intermediate tooth arrangements represent one or more tooth positions between the initial tooth arrangement and the final tooth arrangements as judged proper by an orthodontic practitioner,

fabricating one or more removable aligner capable of moving teeth
from the initial tooth arrangement to one sub-intermediate arrangement;
from one sub-intermediate arrangement to a successive sub-intermediate arrangement to the final tooth arrangement; or
from one sub-intermediate arrangement to the final arrangement.

As used herein, the term sub-intermediate arrangement refers to one intermediate tooth arrangement of two or more intermediate tooth arrangements.

Computer-aided fabrication of tooth aligners are well documented in the art. For example, For example, Kuroda et al. (1996) Am. J. Orthodontics 110:365-369 describes a method for laser scanning a plaster dental cast to produce a digital image of the cast. See also U.S. Pat. No. 5,605,459. U.S. Pat. Nos. 5,533,895; 5,474,448; 5,454,717; 5,447,432; 5,431,562; 5,395,238; 5,368,478; and 5,139,419, assigned to Ormco Corporation, describe methods for manipulating digital images of teeth for designing orthodontic devices.

U.S. Pat. No. 5,011,405 describes a method for digitally imaging a tooth and determining optimum bracket positioning for orthodontic treatment. Laser scanning of a molded tooth to produce a three-dimensional model is described in U.S. Pat. No. 5,338,198. U.S. Pat. No. 5,452,219 describes a method for laser scanning a tooth model and milling a tooth mold. Digital computer manipulation of tooth contours is described in U.S. Pat. Nos. 5,607,305 and 5,587,912. Computerized digital imaging of the jaw is described in U.S. Pat. Nos. 5,342,202 and 5,340,309. Other patents of interest include U.S. Pat. Nos. 5,549,476; 5,382,164; 5,273,429; 4,936,862; 3,860,803; 3,660,900; 5,645,421; 5,055,039; 4,798,534; 4,856,991; 5,035,613; 5,059,118; 5,186,623; and 4,755,139.

The teachings in the above references are incorporated herein in their entirety by reference.

### Appliances

The appliances disclosed herein are intended for use to hold teeth in the one or more intermediate tooth arrangements or the final tooth arrangements, which are described in the description of removable aligners and more above. These appliances provide little or no aligning force, as compared to an aligning force generated by the removable aligner, described above. The relative aligning force between an removable aligner and an appliance can be determined by the mechanical force of the materials forming the removable aligner (e.g., metallic wire, spring, or a relatively harder plastic material) and the polymer forming the appliance.

Polymeric orthodontic appliances are well known in the art, the fabrication of which is well described in, e.g., U.S. Pat. Nos. 6,398,548 and 6,554,611. The teachings in these documents are incorporated herein in their entirety by reference.

### Method of Using

According to a method of the present invention, a user's teeth are repositioned from an initial tooth arrangement to a final tooth arrangement by placing a series of incremental position adjustment removable aligners in the user's mouth. Conveniently, the removable aligners are not affixed and the user may place and replace the removable aligners at any time during the procedure. The first removable aligner of the system will have a geometry selected to reposition the teeth from the initial tooth arrangement to a first intermediate arrangement. After the first intermediate arrangement is approached or achieved, one or more additional (intermediate removable aligners) will be successively placed on the teeth, where such additional removable aligners have geometries selected to progressively reposition teeth from the first intermediate arrangement through successive intermediate arrangement(s). The treatment will be finished by placing a final appliance in the user's mouth, where the final removable aligner has a geometry selected to progressively reposition teeth from the last intermediate arrangement to the final tooth arrangement. The final removable aligner or several removable aligners in the system may have a geometry or geometries selected to over correct the tooth arrangement, i.e. have a geometry which would (if fully achieved) move individual teeth beyond the tooth arrangement which has been selected as the “final.” Such over correction may be desirable in order to offset potential relapse after the repositioning method has been terminated, i.e. to permit some movement of individual teeth back toward their pre-corrected positions. Over correction may also be beneficial to speed the rate of correction, i.e. by having an removable aligner with a geometry that is positioned beyond a desired intermediate or final position, the individual teeth will be shifted toward the position at a greater rate. In such cases, treatment can be terminated before the teeth reach the positions defined by the final removable aligner or removable aligners.

The removable aligners can be used in the day time or night time. In some embodiments, it is used in the night.

Appliances can be used to hold teeth in an intermediate arrangement or a final tooth arrangement, described above. The appliances can be used in the day time or night time. In some embodiments, it is used in the day time.

It must be noted that the use of removable aligners can be highly flexible. For example, in some embodiments, one can wear a removable aligner continuously or intermittently as long as a corresponding appliance is used when one removes the removable aligner in use. For example, one can wear a removable aligner for a period of 24 hrs, over night, or every other day, as long as he wears a corresponding appliance is used when he/she removes the removable aligner in use.

The system can be used to treat or prevent orthodontic conditions such as malalignment, crowding, spacing, overjet, overbite problem, and a combination thereof.

While the above is a complete description of the preferred embodiments of the invention, various alternatives, modifications, and equivalents may be used. Therefore, the above description should not be taken as limiting the scope of the invention which is defined by the appended claims.

1. A system for repositioning teeth from an initial arrangement to a final arrangement, the system comprising:
a) at least one removable aligner having a geometry selected to reposition the teeth from the initial arrangement to an intermediate arrangement or the final arrangement,
b) at least one appliance having a corresponding geometry of the intermediate arrangement or the final arrangement;
wherein the removable aligner provides an aligning force to progressively reposition the teeth from the initial arrangement to the intermediate arrangement or the final arrangement;
wherein the appliance holds the teeth in the intermediate arrangement or the final arrangement.

2. The system of claim 1, wherein the intermediate arrangement comprises two or more sequential sub-intermediate arrangements,
wherein the system comprises two or more removable aligners and two or more appliances,
wherein the removable aligners progressively reposition the teeth:
from the initial tooth arrangement to one sub-intermediate arrangement;
from one sub-intermediate arrangement to a successive sub-intermediate arrangement to the final tooth arrangement; or
from one sub-intermediate arrangement to the final arrangement; and
wherein the appliances hold the teeth in the one sub-intermediate arrangement, the successive sub-intermediate, or the final arrangement.

3. The system of claim 2, comprising 3 or more removable aligners and 3 or more appliances.

4. The system of claim 2, comprising 4 or more removable aligners and 4 or more appliances.

5. The system of claim 2, comprising 5 or more removable aligners and 5 or more appliances.

6. The system of claim 1, wherein the appliance comprises polymeric shells having cavities shaped to receive and hold teeth in the intermediate arrangement or the final arrangement.

7. The system of claim 2, wherein the appliances comprise appliances polymeric shells having cavities shaped to receive and hold the teeth in the one sub-intermediate arrangement, the successive sub-intermediate, or the final arrangement.

8. The system of claim 1, wherein the linear distance from the initial arrangement to the intermediate arrangement is at least 0.2 mm.

9. The system of claim 1, wherein the linear distance from the initial arrangement to the intermediate arrangement is at least 0.5 mm.

10. The system of claim 2, wherein the linear distance:
from the initial tooth arrangement to one sub-intermediate arrangement is at least 0.2 mm;
from one sub-intermediate arrangement to a successive sub-intermediate arrangement to the final tooth arrangement is at least 0.2 mm; or
from one sub-intermediate arrangement to the final arrangement is at least 0.2 mm.

11. The system of claim 2, wherein the linear distance:
from the initial tooth arrangement to one sub-intermediate arrangement is at least 0.5 mm;
from one sub-intermediate arrangement to a successive sub-intermediate arrangement to the final tooth arrangement is at least 0.5 mm; or
from one sub-intermediate arrangement to the final arrangement is at least 0.5 mm.

12. A method of fabricating a system for repositioning teeth from an initial arrangement to a final arrangement, the method comprising:
a) forming at least one removable aligner having a geometry selected to reposition the teeth from the initial arrangement to an intermediate arrangement or the final arrangement,
b) forming at least one appliance having a corresponding geometry of the intermediate arrangement or the final arrangement;
wherein the removable aligner provides an aligning force to progressively reposition the teeth from the initial arrangement to the intermediate arrangement or the final arrangement;
wherein the appliance holds the teeth in the intermediate arrangement or the final arrangement.

13. The method of claim 12, wherein the intermediate arrangement comprises two or more sequential sub-intermediate arrangements,
wherein the system comprises two or more removable aligners and two or more appliances,
wherein the removable aligners progressively reposition the teeth:
from the initial tooth arrangement to one sub-intermediate arrangement;
from one sub-intermediate arrangement to a successive sub-intermediate arrangement to the final tooth arrangement; or
from one sub-intermediate arrangement to the final arrangement; and
wherein the appliances hold the teeth in the one sub-intermediate arrangement, the successive sub-intermediate, or the final arrangement.

14. The method of claim 13, wherein the system comprises 3 or more removable aligners and 3 or more appliances.

15. The method of claim 13, wherein the system comprises 4 or more removable aligners and 4 or more appliances.

16. The method of claim 13, wherein the system comprises 5 or more removable aligners and 5 or more appliances.

17. The method of claim 1, wherein the appliance comprises polymeric shells having cavities shaped to receive and hold teeth in the intermediate arrangement or the final arrangement.

18. The method of claim 13, wherein the appliances comprise appliances polymeric shells having cavities shaped to receive and hold the teeth in the one sub-intermediate arrangement, the successive sub-intermediate, or the final arrangement.

19. The method of claim 12, wherein the linear distance from the initial arrangement to the intermediate arrangement is at least 0.2 mm.

20. The method of claim 12, wherein the linear distance from the initial arrangement to the intermediate arrangement is at least 0.5 mm.

21. The method of claim 13, wherein the linear distance:
from the initial tooth arrangement to one sub-intermediate arrangement is at least 0.2 mm;
from one sub-intermediate arrangement to a successive sub-intermediate arrangement to the final tooth arrangement is at least 0.2 mm; or
from one sub-intermediate arrangement to the final arrangement is at least 0.2 mm.

22. The method of claim 13, wherein the linear distance:
from the initial tooth arrangement to one sub-intermediate arrangement is at least 0.5 mm;
from one sub-intermediate arrangement to a successive sub-intermediate arrangement to the final tooth arrangement is at least 0.5 mm; or
from one sub-intermediate arrangement to the final arrangement is at least 0.5 mm.

23. A method of aligning teeth, comprising applying to a patient a system according to claim 1.

24. The method of claim 23, wherein the teeth have a disorder selected from the group consisting of malalignment, crowding, spacing, overjet, overbite problem, and a combination thereof.
